(19) United States
(12) Patent Application Publication
(10) Pub. No.: US 2024/0266130 A1
(43) Pub. Date: Aug. 8, 2024

(54) GFCI Socket

(71) Applicants: Yangen Chen, Wenzhou City (CN); Jingzheng Chen, Wenzhou City (CN)

(72) Inventors: Yangen Chen, Wenzhou City (CN); Jingzheng Chen, Wenzhou City (CN)

(73) Assignee: Zhejiang Yuchuang Electronic Technology Co, Ltd., Wenzhou City (CN)

(21) Appl. No.: 18/314,827

(22) Filed: May 10, 2023

(30) Foreign Application Priority Data
Feb. 3, 2023 (CN) 2023100528191

(51) Int. Cl. H01H 50/54; H01H 50/02

(52) U.S. Cl. CPC H01H 50/546; H01H 50/02

(57) ABSTRACT

A ground fault circuit interrupter (GFCI) socket. The socket includes a housing, where a first circuit board is arranged in the housing, a plurality of sets of jacks, conductive sheets, a safety door assembly, and a test key and a reset key are movably arranged on the housing in a penetrating manner. The housing includes an upper housing, a middle frame and a lower housing that are detachably connected, the safety door assembly is arranged between the upper housing and the middle frame, and the safety door assembly is provided with an elastic member for promoting the safety door assembly to shield the jacks. The middle frame forms a base of safety doors, an operation structure is arranged between the two sets of jacks, and the operation structure includes a linkage frame and contact bridges movably arranged on left and right sides of the linkage frame.

### TECHNICAL FIELD

The present invention relates to the technical field of leakage protectors, and in particular to a ground fault circuit interrupter (GFCI) socket.

### BACKGROUND ART

A ground fault circuit interrupter (GFCI) is a ground fault leakage protector, which is a device intended to protect people from severe or fatal electric shock. And since the GFCI detects a ground fault, the GFCI can also prevent some electrical fires and interrupt currents harming people seriously. The working principle is as follows: in a household wiring system, on one power socket, a current of a live wire and a current of a neutral wire should be equal in a normal case. The GFCI monitors a current difference between the live wire and the neutral wire, and once the difference is greater than 4-6 milliamperes, the GFCI can cut off a power supply to prevent fatal power, thereby ensuring personal safety.

For an instance, disclosed in the invention patent with the application No. 20/048,0006812.1 is a GFCI socket equipped with a plug blocking device. The GFCI socket includes a housing, a circuit interrupting portion, a reset portion, a reset button, and a molded member located within the housing, is controlled by the circuit interrupting portion to block a third connection from being connected to a user-accessible load when the circuit interrupting portion is unavailable, a neutral state of interruption exists, or a reverse wiring conditions exists, where the housing includes a surface portion, a central main body and a bottom. Most of safety doors of GFCI sockets similar to such a GFCI socket in the market cooperate with surface portions, such that the overall thickness of the GFCI sockets is relatively large, the production cost is increased, moreover, space reserved for the GFCI needs to be large enough during mounting, and certain limitations are caused. In addition, a linkage operation mechanism of the reset button of such a GFCI socket is complex in structure, and high in mounting space requirements, resulting in an excessive overall size of the GFCI socket.

### SUMMARY

In view of the defects in the background art, the present invention provides a ground fault circuit interrupter (GFCI) socket capable of reducing an overall thickness, compact in structure and smaller in size so as to solve the technical problems.

To this end, the present invention employs the following technical solutions for achievement:

A GFCI socket includes a housing, where a first circuit board is arranged in the housing, and a plurality of sets of jacks are provided in the housing. Conductive sheets aligned with the jacks are arranged in the housing, a safety door assembly capable of shielding the jacks is arranged in the housing, and a test key and a reset key are movably arranged on the housing in a penetrating manner. The housing includes an upper housing, a middle frame and a lower housing that are detachably connected, the safety door assembly is arranged between the upper housing and the middle frame, and the safety door assembly is provided with an elastic member for promoting the safety door assembly to shield the jacks. The middle frame forms a base of safety doors, an operation structure is arranged between the two sets of jacks, and the operation structure includes a linkage frame and contact bridges movably arranged on left and right sides of the linkage frame.

Furthermore, the safety door assembly includes the safety doors and fixing seats, the two sets of jacks are provided, first slots allowing the conductive sheets to be inserted thereinto are arranged in the middle frame, and protruding portions are arranged at the positions, at outer rings of the first slots, of the middle frame. Left sides of the fixing seats are provided with sixth through holes aligned with the left conductive sheets, right sides are provided with seventh through holes aligned with the right conductive sheets, the portions, on upper and lower sides of the seventh through holes, of the fixing seats are provided with first slopes, inner ends of the first slopes abut against outer side surfaces of the protruding portions, upper and lower sides of the safety doors are provided with second slopes in sliding fit with the first slopes, and the second slopes are in sliding fit with the first slopes to promote the safety doors to move to expose the conductive sheets.

Furthermore, a sliding groove allowing the safety doors to slide therein is provided in the upper housing, the elastic member is of an elastic sheet arranged on a right side of the upper housing, and upper and lower sides of the elastic sheet are bent inwards and extend into the sliding groove and abut against the corresponding safety doors respectively. Eighth through holes capable of being aligned with the seventh through holes are provided in middles of the safety doors, the portions, on left and right sides of the eighth through holes, of the safety doors are provided with inclined faces aligned with the jacks, first clamping blocks are arranged on upper and lower sides of the seventh through holes, and grooves allowing the first clamping blocks to be inserted thereinto are provided in inner side faces of the safety doors.

Furthermore, two ends of the contact bridges are provided with movable contacts, the conductive sheets are provided with first static contacts aligned with the movable contacts at upper ends of the contact bridges, one end of the first circuit board is connected to a mutual inductor, the mutual inductor is provided with second static contacts aligned with the movable contacts at lower ends of the contact bridges, and a lower end of the reset key is provided with a driving structure capable of being linked with the linkage frame.

Furthermore, the driving mechanism includes a driving rod and a lock catch arranged at a lower portion of the driving rod, a first spring driving the reset key to reset is arranged on the driving rod in a sleeving manner, and a locking plate capable of cooperating with the lock catch is movably arranged in the linkage frame. The first circuit board is connected to an electromagnet, the electromagnet includes a static iron core and a movable iron core, an annular groove is provided in an outer side of the movable iron core, and a fourth spring is arranged between the movable iron core and the static iron core. A first through hole allowing the driving rod to be inserted thereinto is provided in the linkage frame, and a second through hole allowing the locking plate to move therein is provided in the linkage frame. The locking plate is provided with a third through hole allowing the driving rod and the lock catch to pass therethrough, and blocking sheets capable of moving in the annular groove are arranged at two ends of one side of the locking plate.

Furthermore, a movable frame is arranged on the linkage frame, a fourth through hole allowing the driving rod to be inserted thereinto is provided in the movable frame, a second clamping block is arranged on the movable frame, and a touch plate is detachably connected onto the movable frame. A convex portion allowing the second clamping block to be buckled is arranged on the linkage frame, a contact capable of abutting against the touch plate is arranged on the first circuit board, and a third spring for promoting the movable frame to move outwards is arranged between the movable frame and the linkage frame. A first convex block is arranged on the movable frame, and a first buckle capable of being buckled with the first convex block is arranged on the touch plate.

Furthermore, a support is arranged on the middle frame, a second circuit board is arranged on the support, and a contact piece connected to the first circuit board is arranged on the support and the middle frame in a penetrating manner. A swing sheet is bent inwards at an upper end of the contact piece, a lower end of the test key abuts against the swing sheet, a contact capable of abutting against the swing sheet is arranged on the second circuit board, and an indicator lamp penetrating out of the housing is arranged on the second circuit board. The first spring is arranged between the middle frame and the reset key.

Furthermore, the middle frame is provided with a second slot allowing the linkage frame to move therein, the linkage frame is provided with guide opening grooves and guide stand columns, the contact bridges are provided with guide sheets movable in the guide opening grooves, and the contact bridges are provided with fifth through holes allowing the guide stand columns to pass therethrough. A lower end of the middle frame is provided with a sleeve, and the sleeve is internally provided with second springs which are arranged on the guide stand columns in a sleeving manner and abut against the contact bridges.

Furthermore, an opening is provided in a middle of the elastic sheet, a positioning block inserted into the opening is arranged in the upper housing, at least one pair of first stand columns for clamping and limiting left-right swing of the elastic sheet are arranged in each of the positions, on upper and lower sides of the positioning block, and second stand columns capable of abutting against the bent portions of the elastic sheet are further arranged in the upper housing.

Furthermore, left and right sides of the lower housing each are provided with a second buckle, and a periphery of the lower housing is provided with first screw holes. The upper housing is provided with second convex blocks capable of being buckled with the second buckles, and the upper housing is provided with second screw holes aligned with the first screw holes. The first screw holes and the second screw holes are in threaded connection through bolts, and the middle frame is provided with ninth through holes for the bolts to pass therethrough.

After the above technical solutions are employed, the housing is composed of the upper housing, the middle frame and the lower housing, the safety door assembly is located between the upper housing and the middle frame, and the middle frame forms the base of the safety doors, such that the overall structure is more compact, an overall thickness of the GFCI socket is reduced, and a size is smaller. The production cost is reduced, moreover, requirements for mounting space are lower, and stronger applicability is achieved. In addition, the operation structure linked with the reset key is retracted and integrated between the two sets of jacks, and such space is effectively utilized, such that the internal structure is more compact, and the size and the thickness of the GFCI socket are reduced, thereby achieving the purpose of an ultrathin and ultra-small size of a GFCI is achieved.

### BRIEF DESCRIPTION OF THE DRAWINGS

FIG. 1 is a perspective schematic structural diagram of the present invention;

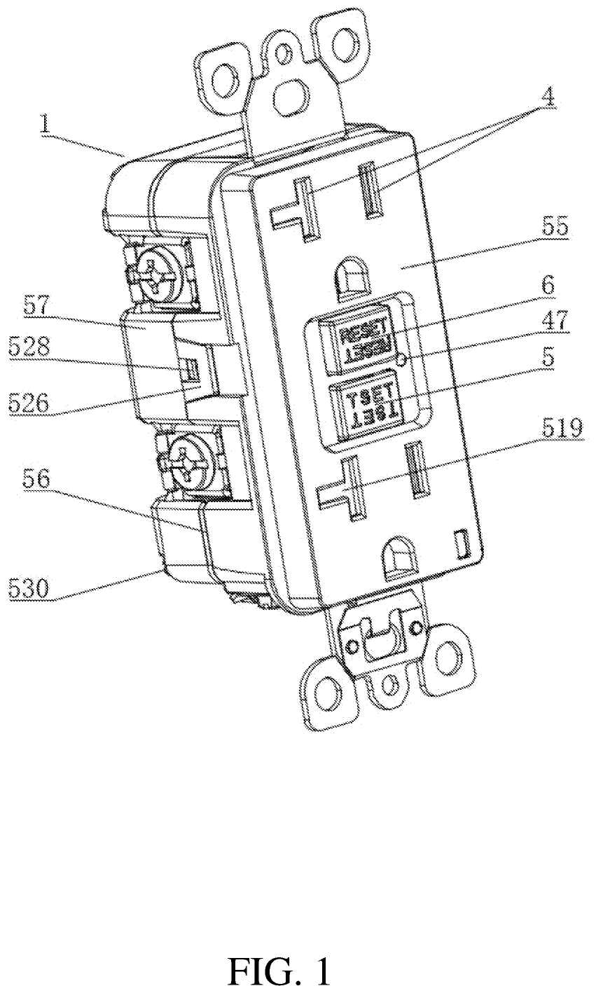

FIG. 2 is a schematic structural diagram from a front view of the present invention;

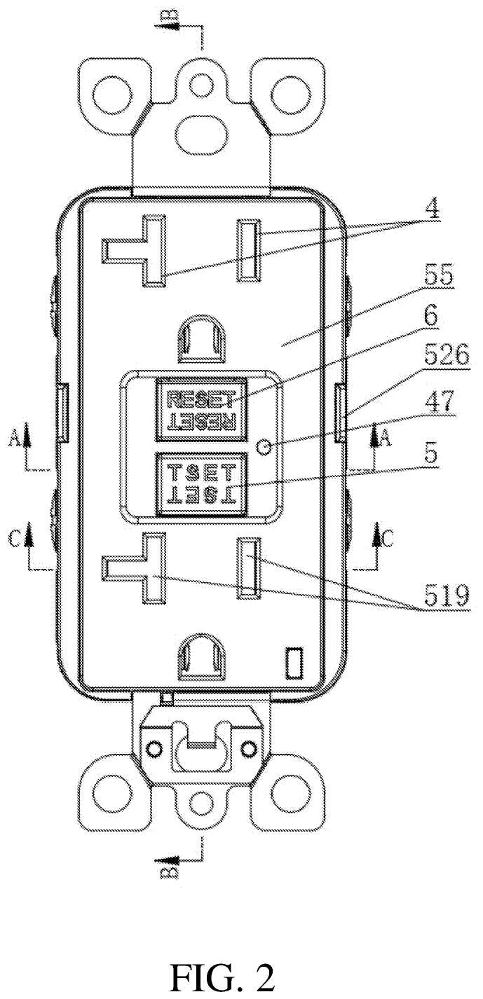

FIG. 3 is a sectional view of an A-A direction in FIG. 2;

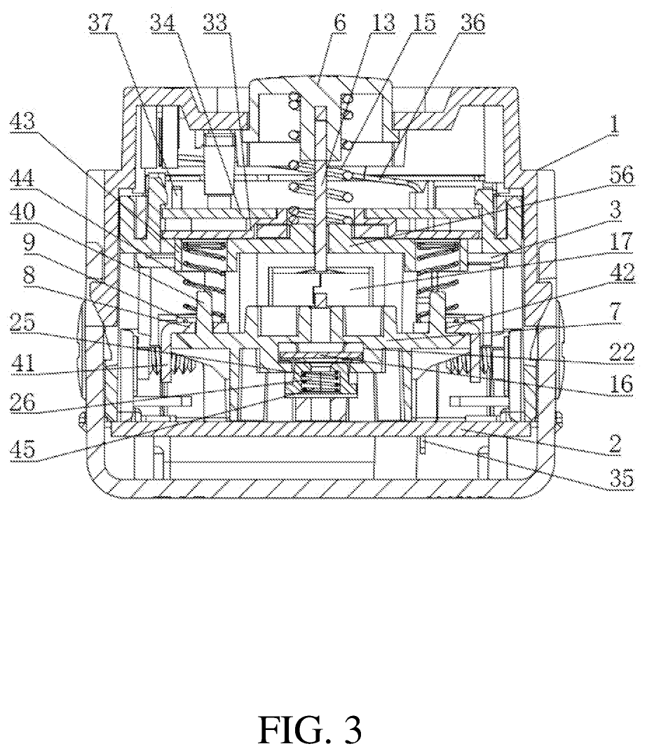

FIG. 4 is a sectional view of a B-B direction in FIG. 2;

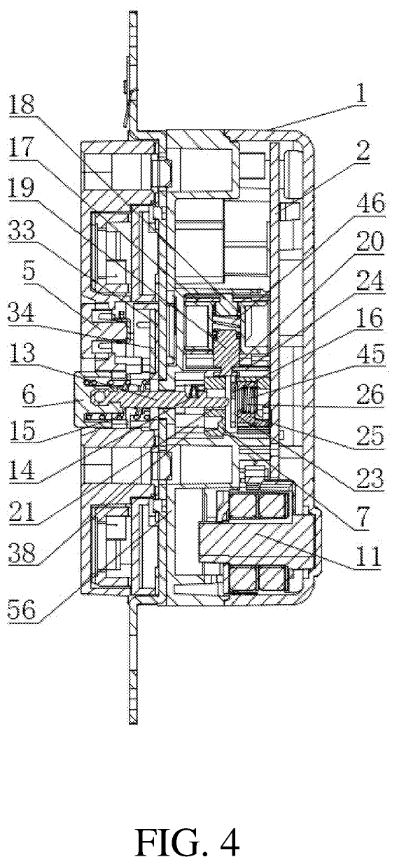

FIG. 5 is a sectional view of a C-C direction in FIG. 2;

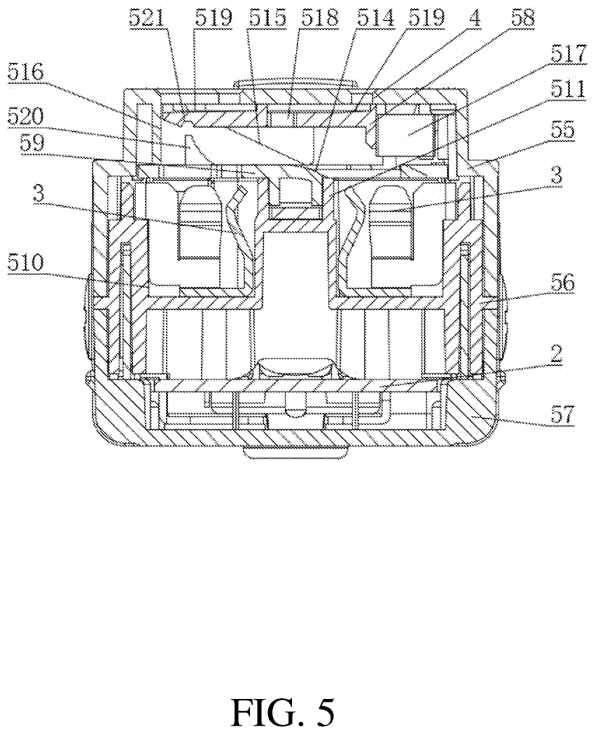

FIG. 6 is a perspective schematic structural diagram without an upper housing of the present invention;

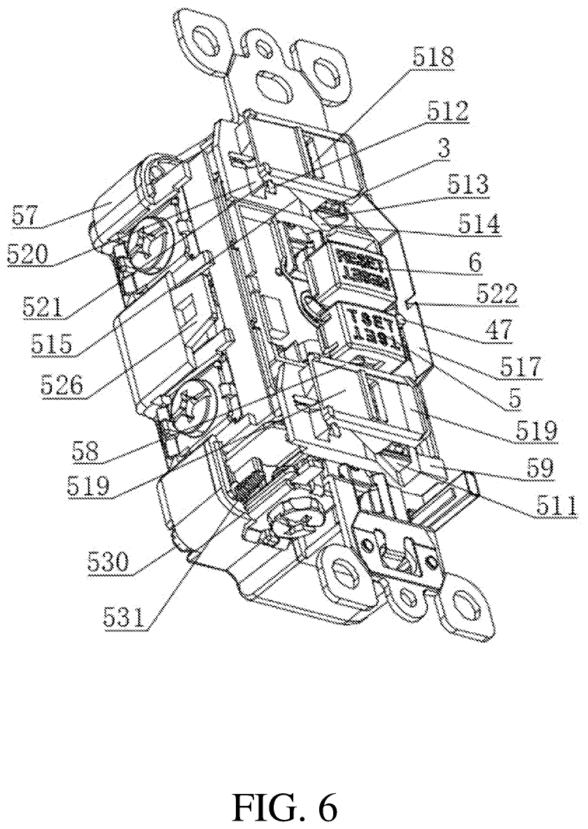

FIG. 7 is a perspective schematic structural diagram of an upper housing and an elastic sheet in the present invention;

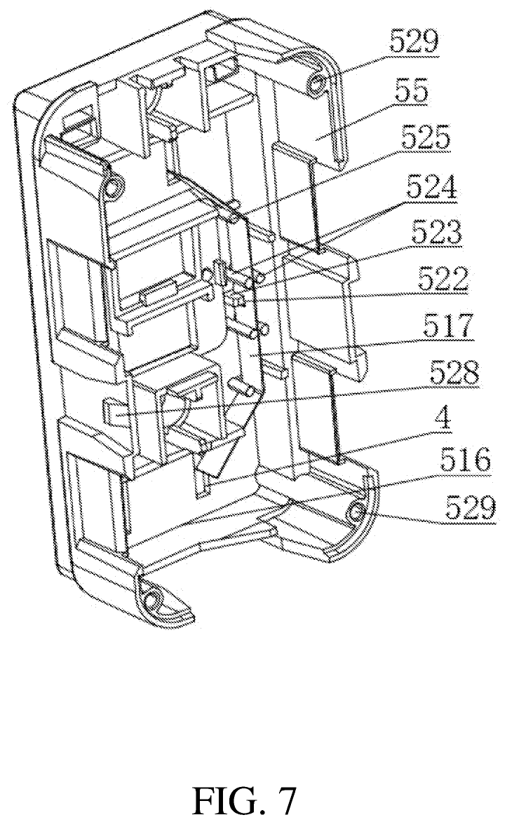

FIG. 8 is a perspective schematic diagram of an internal structure of the present invention;

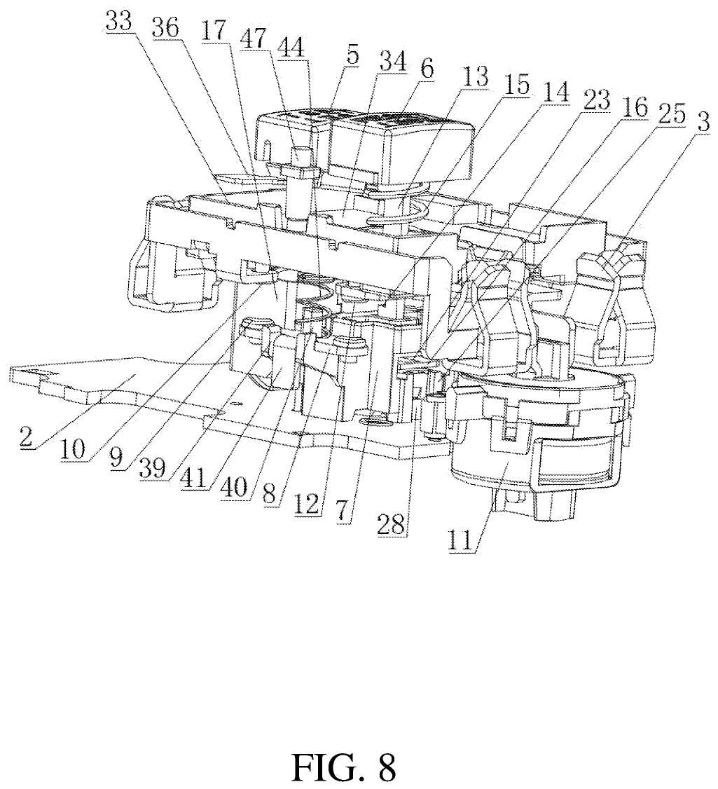

FIG. 9 is a perspective schematic structural diagram of a reset key and an operation structure in the present invention; and

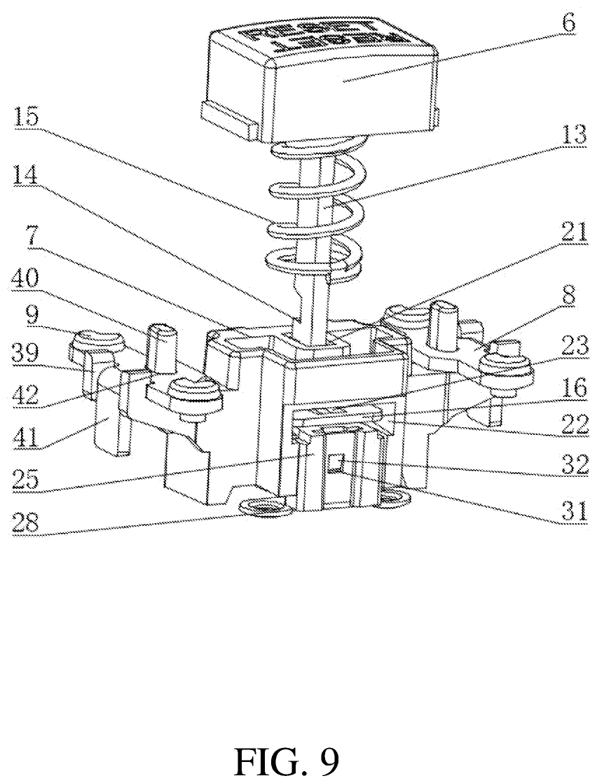

FIG. 10 is a schematic structural diagram in another visual direction of FIG. 9.

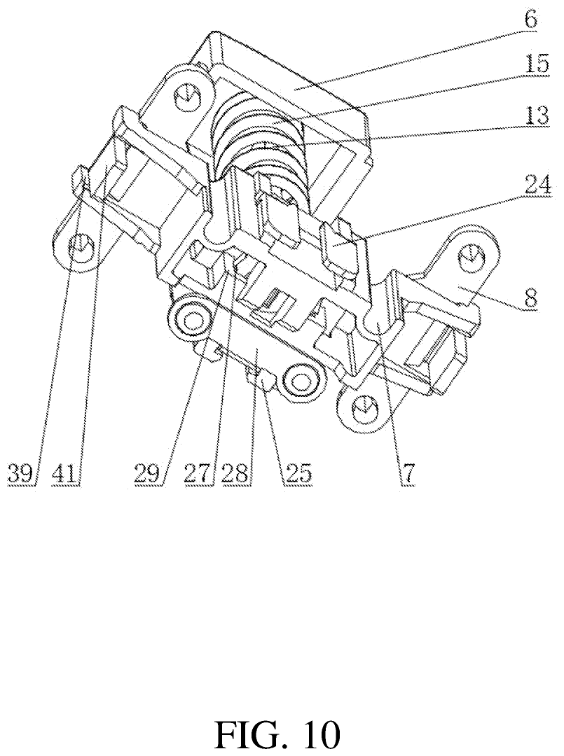

Reference numerals: 1, housing; 2, first circuit board; 3, conductive sheet; 4, jack; 5, test key; 6, reset key; 7, linkage frame; 8, contact bridge; 9, movable contact; 10, first static contact; 11, mutual inductor; 12, second static contact; 13, driving rod; 14, lock catch; 15, first spring; 16, locking plate; 17, electromagnet; 18, static iron core; 19, movable iron core; 20, annular groove; 21, first through hole; 22, second through hole; 23, third through hole; 24, blocking sheet; 25, movable frame; 26, fourth through hole; 27, second clamping block; 28, touch plate; 29, convex portion; 30, first buckle; 31, first convex block; 33, support; 34, second circuit board; 35, contact piece; 36, swing sheet; 37, contact; 38, second slot; 39, guide opening groove; 40, guide stand column; 41, guide sheet; 42, fifth through hole; 43, sleeve; 44, second spring; 45, third spring; 46, fourth spring; 47, indicator lamp; 55, upper housing; 56, middle frame; 57, lower housing; 58, safety door; 59, fixing seat; 510, first slot; 511, protruding portion; 512, sixth through hole; 513, seventh through hole; 514, first slope; 515, second slope; 516, sliding groove; 517, elastic sheet; 518, eighth through hole; 519, inclined face; 520, first clamping block; 521, groove; 522, opening; 523, positioning block; 524, first stand column; 525, second stand column; 526, second buckle; 528, second convex block; 529, second screw hole; 530, bolt; and 531, ninth through hole.

### DETAILED DESCRIPTION OF THE EMBODIMENTS

In order to further illustrate the technical means used for achieving the intended purpose of the present invention and the technical effects of the present invention, the particular embodiments, structures and features of the present invention, and effects thereof are described in detail hereinafter in conjunction with the accompanying drawings and preferred examples.

With reference to the above accompanying drawings, the present invention provides a ground fault circuit interrupter (GFCI) socket. The socket includes a housing 1, where a first circuit board 2 is arranged in the housing 1, and a plurality of sets of jacks 4 are provided in the housing 1. Conductive sheets 3 aligned with the jacks 4 are arranged in the housing 1, a safety door assembly capable of shielding the jacks 4 is arranged in the housing 1, and a test key 5 and a reset key 6 are movably arranged on the housing 1 in a penetrating manner. The housing 1 includes an upper housing 55, a middle frame 56 and a lower housing 57 that are detachably connected, the safety door assembly is arranged between the upper housing 55 and the middle frame 56, and the safety door assembly is provided with an elastic member for promoting the safety door assembly to shield the jacks 4. The middle frame 56 forms a base of safety doors 58, an operation structure is arranged between the two sets of jacks 4, and the operation structure includes a linkage frame 7 and contact bridges 8 movably arranged on left and right sides of the linkage frame 7. The safety door assembly includes the safety doors 58 and fixing seats 59, the two sets of jacks 4 are provided, first slots 510 allowing the conductive sheets 3 to be inserted thereinto are arranged in the middle frame 56, and protruding portions 511 are arranged at the positions, at outer rings of the first slots 510, of the middle frame 56. Left sides of the fixing seats 59 are provided with sixth through holes 512 aligned with the left conductive sheets 3, right sides are provided with seventh through holes 513 aligned with the right conductive sheets 3, the portions, on upper and lower sides of the seventh through holes 513, of the fixing seats 59 are provided with first slopes 514, inner ends of the first slopes 514 abut against outer side surfaces of the protruding portions 511, upper and lower sides of the safety doors 58 are provided with second slopes 515 in sliding fit with the first slopes 514, and the second slopes 515 are in sliding fit with the first slopes 514 to promote the safety doors 58 to move to expose the conductive sheets 3. A sliding groove 516 allowing the safety doors 58 to slide therein is provided in the upper housing 55, the elastic member is of an elastic sheet 517 arranged on a right side of the upper housing 55, and upper and lower sides of the elastic sheet 517 are bent inwards and extend into the sliding groove 516 and abut against the corresponding safety doors 58 respectively. Eighth through holes 518 capable of being aligned with the seventh through holes 513 are provided in middles of the safety doors 58, the portions, on left and right sides of the eighth through holes 518, of the safety doors 58 are provided with inclined faces 519 aligned with the jacks 4, first clamping blocks 520 are arranged on upper and lower sides of the seventh through holes 513, and grooves 521 allowing the first clamping blocks 520 to be inserted thereinto are provided in inner side faces of the safety doors 58. Two ends of the contact bridges 8 are provided with movable contacts 9, the conductive sheets 3 are provided with first static contacts 10 aligned with the movable contacts 9 at upper ends of the contact bridges 8, one end of the first circuit board 2 is connected to a mutual inductor 11, the mutual inductor 11 is provided with second static contacts 12 aligned with the movable contacts 9 at lower ends of the contact bridges 8, and a lower end of the reset key 6 is provided with a driving structure capable of being linked with the linkage frame 7. The driving mechanism includes a driving rod 13 and a lock catch 14 arranged at a lower portion of the driving rod 13, a first spring 15 driving the reset key 6 to reset is arranged on the driving rod 13 in a sleeving manner, and a locking plate 16 capable of cooperating with the lock catch 14 is movably arranged in the linkage frame 7. The first circuit 2 is connected to an electromagnet 17, the electromagnet 17 includes a static iron core 18 and a movable iron core 19, an annular groove 20 is provided in an outer side of the movable iron core 19, and a fourth spring 46 is arranged between the movable iron core 19 and the static iron core 18. A first through hole 21 allowing the driving rod 13 to be inserted thereinto is provided in the linkage frame 7, and a second through hole 22 allowing the locking plate 16 to move therein is provided in the linkage frame 7. The locking plate 16 is provided with a third through hole 23 allowing the driving rod 13 and the lock catch 14 to pass therethrough, and blocking sheets 24 capable of moving in the annular groove 20 are arranged at two ends of one side of the locking plate 16. A movable frame 25 is arranged on the linkage frame 7, a fourth through hole 26 allowing the driving rod 13 to be inserted thereinto is provided in the movable frame 7, a second clamping block 27 is arranged on the movable frame 7, and a touch plate 28 is detachably connected onto the movable frame 25. A convex portion 29 allowing the second clamping block 27 to be buckled is arranged on the linkage frame 7, a contact 37 capable of abutting against the touch plate 28 is arranged on the first circuit board 2, and a third spring 45 for promoting the movable frame 25 to move outwards is arranged between the movable frame 25 and the linkage frame 7. A first convex block 31 is arranged on the movable frame 25, and a first buckle 30 capable of being buckled with the first convex block 31 is arranged on the touch plate 28. A support 33 is arranged on the middle frame 56, a second circuit board 34 is arranged on the support 33, and a contact piece 35 connected to the first circuit board 2 is arranged on the support 33 and the middle frame 56 in a penetrating manner. A swing sheet 36 is bent inwards at an upper end of the contact piece 35, a lower end of the test key 5 abuts against the swing sheet 36, a contact 37 capable of abutting against the swing sheet 36 is arranged on the second circuit board 34, and an indicator lamp 47 penetrating out of the housing 1 is arranged on the second circuit board 34. When the socket is normal, the indicator lamp 47 is blue, and when the socket is faulty, the indicator lamp 47 is red, such that states of the socket are convenient to distinguish. The first spring 15 is arranged between the middle 56 and the reset key 6. The middle frame 56 is provided with a second slot 38 allowing the linkage frame 7 to move therein, the linkage frame 7 is provided with guide opening grooves 39 and guide stand columns 40, the contact bridges 8 are provided with guide sheets 41 movable in the guide opening grooves 39, and the contact bridges 8 are provided with fifth through holes 42 allowing the guide stand columns 40 to pass therethrough. A lower end of the middle frame 56 is provided with a sleeve 43, and the sleeve 43 is internally provided with second springs 44 which are arranged on the guide stand columns 40 in a sleeving manner and abut against the contact bridges 8. An opening 522 is provided in a middle of the elastic sheet 517, a positioning block 523 inserted into the opening 522 is arranged in the upper housing 55, at least one pair of first stand columns 524 for clamping and limiting left-right swing of the elastic sheet 517 are arranged in each of the positions, on upper and lower sides of the positioning block 523, and second stand columns 525 capable of abutting against the bent portions of the elastic sheet 517 are further arranged in the upper housing 55. Left and right sides of the lower housing 57 each are provided with a second buckle 526, and a periphery of the lower housing 57 is provided with first screw holes. The upper housing 55 is provided with second convex blocks 528 capable of being buckled with the second buckles 526, and the upper housing 55 is provided with second screw holes 529 aligned with the first screw holes. The first screw holes and the second screw holes 529 are in threaded connection through bolts 530, and the middle frame 56 is provided with ninth through holes 531 for the bolts 530 to pass therethrough.

The working principle of the present invention is as follows:

When the GFCI socket is used each time, the socket should be tested once to ensure whether the socket works normally. During testing, a lamp is first inserted into the jacks 4, and at this time, the lamp is powered on and turned on. Then the test key 5 is pressed once to drive the swing sheet 36 to swing, when the swing sheet 36 is in contact with the contact 37 on the second circuit board 34, the electromagnet 17 is started and powered on to move the movable iron core 19 inwards to be adsorbed on the static iron core 18, and the annular groove 20 and the blocking sheets 24 cooperate to drive the locking plate 16 to move, such that the third through hole 23 is separated from the lock catch 14. At this time, the driving rod 13 and the reset key 6 are ejected outwards under acting force of the first spring 15, meanwhile, the contact bridges 8 and the linkage frame 7 move under an action of the second springs 44, such that the movable contacts 9 are separated from the first static contacts 10 and the second static contacts 12, the socket is powered off, and the lamp is extinguished. If the reset key 6 fails to be ejected, it is indicated that the socket is faulty and should be replaced in time. If the function is intact, after the lamp is extinguished, the reset key 6 is pressed to drive the driving rod 13 to move and enable the lock catch 14 to abut against the locking plate 16, and the reset key 6 is continued to be pressed to abut against and drive the locking plate 16, the movable frame 25 and the linkage frame 7 to move. When the movable contact piece 35 abuts against the contact, the electromagnet 17 is started to be electrified to enable the movable iron core 19 to move inwards to be adsorbed on the static iron core 18, the annular groove 20 and the blocking sheets 24 cooperate to drive the locking plate 16 to move to enable the third through hole 23 to be separated from the lock catch 14. At the moment, the lock catch 14 continues to move downwards to penetrate the third through hole 23, and after the reset key 6 is loosened, the movable frame 25 drives the movable contact piece 35 to be separated from the contact 37 on the second circuit board 34 under an action of the third spring 45. At the moment, the electromagnet 17 is powered off, the movable iron core 19 moves outwards under acting force of the fourth spring 46 to drive the locking plate 16 to be inserted into the lock catch 14 to complete locking of the driving rod 13 and the reset key 6. Meanwhile, the reset key 6 moves under the action of the first spring 15 to drive the locking plate 16, the linkage frame 7 and the contact bridges 8 to move, such that the movable contacts 9 abut against the first static contacts 10 and the second static contacts 12, and the socket is normally powered on. When a plug of an electric appliance is inserted into the jacks 4 and abuts against the inclined faces 519 of the safety doors 58, the plug is continued to be pressed to cooperate with the inclined faces 519 to make the safety doors 58 move rightwards. When the eighth through holes 518 are aligned with the jacks 4, one end of the plug passes through the eighth through holes 518 and the seventh through holes 513 and abuts against the conductive sheets 3, and the other end of the plug passes through left end faces of the safety doors 58 and passes through the sixth through holes 512 and abuts against the conductive sheets 3. After the plug of the electric appliance is pulled out, the safety doors 58 move towards the left side of the sliding groove 516 under acting force of the elastic sheet 517 and shield the jacks 4.

In the example, the housing 1 is composed of the upper housing 55, the middle frame 56 and the lower housing 57, the safety door assembly is located between the upper housing 55 and the middle frame 56, and the middle frame 56 forms the base of the safety doors 58, such that the overall structure is more compact, an overall thickness of the ground fault circuit interrupter (GFCI) socket is reduced, and a size is smaller. The production cost is reduced, moreover, requirements for mounting space are lower, and stronger applicability is achieved. The operation structure linked with the reset key 6 is contracted and integrated between the two sets of jacks 4, and such space is effectively utilized, such that the internal structure is more compact, and the size and the thickness of the GFCI socket are reduced, thereby achieving the purpose of an ultrathin and ultra-small size of a GFCI is achieved. In addition, the mutual inductor 11 and the first circuit board 2 are changed into a side-by-side design from an existing upper and lower laminated design, such that the overall thickness of the GFCI is further reduced. The protruding portions 511 and the fixing seats 59 cooperate to prevent the fixing seats 59 from moving, and therefore, the structure is stabler. When the left end of the plug is inserted into the jacks 4, the safety doors 58 will be driven to swing, such that the first clamping blocks 520 is inserted into the grooves 521, at this time, the safety doors 58 fail to be opened, only the two ends of the plug are inserted into the jacks 4 at the same time and pressed on the inclined faces 519, the safety doors 58 may be promoted to move rightwards, and safety is higher. The opening 522 and the positioning block 523 may prevent displacement of the elastic sheet 517, and therefore, structural stability is better. Arrangement of the first stand columns 524 may prevent the elastic sheet 517 from swinging left and right, such that an action of the elastic sheet 517 and the safety doors 58 is more accurate.

The foregoing descriptions are merely preferred examples of the present invention, and are not intended to limit the present invention in any form. Although the present invention has been disclosed as above by means of the preferred examples, these examples are not for defining the present invention. Those skilled in the art can make certain alterations or modifications by using the technical contents disclosed above without departing from the scope of the technical solutions of the present invention so as to arrive at equivalent examples with equivalent changes. However, any simple amendments, equivalent changes, and modifications made to the above examples according to the technical essence of the present invention without departing from the contents of the technical solutions of the present invention still fall within the scope of the technical solutions of the present invention.

What is claimed is:

1. A ground fault circuit interrupter (GFCI) socket, comprising a housing, wherein a first circuit board is arranged in the housing, a plurality of sets of jacks are provided in the housing, conductive sheets aligned with the jacks are arranged in the housing, a safety door assembly capable of shielding the jacks is arranged in the housing, a test key and a reset key are movably arranged on the housing in a penetrating manner, the housing comprises an upper housing, a middle frame and a lower housing that are detachably connected, the safety door assembly is arranged between the upper housing and the middle frame, the safety door assembly is provided with an elastic member for promoting the safety door assembly to shield the jacks, the middle frame forms a base of safety doors, an operation structure is arranged between the two sets of jacks, and the operation structure comprises a linkage frame and contact bridges movably arranged on left and right sides of the linkage frame.

2. The GFCI socket according to claim 1, wherein the safety door assembly comprises the safety doors and fixing seats, the two sets of jacks are provided, first slots allowing the conductive sheets to be inserted thereinto are arranged in the middle frame, protruding portions are arranged at the positions, at outer rings of the first slots, of the middle frame, left sides of the fixing seats are provided with sixth through holes aligned with the left conductive sheets, right sides are provided with seventh through holes aligned with the right conductive sheets, the portions, on upper and lower sides of the seventh through holes, of the fixing seats are provided with first slopes, inner ends of the first slopes abut against outer side surfaces of the protruding portions, upper and lower sides of the safety doors are provided with second slopes in sliding fit with the first slopes, and the second slopes are in sliding fit with the first slopes to promote the safety doors to move to expose the conductive sheets.

3. The GFCI socket according to claim 2, wherein a sliding groove allowing the safety doors to slide therein is provided in the upper housing, the elastic member is of an elastic sheet arranged on a right side of the upper housing, upper and lower sides of the elastic sheet are bent inwards and extend into the sliding groove and abut against the corresponding safety doors respectively, eighth through holes capable of being aligned with the seventh through holes are provided in middles of the safety doors, the portions, on left and right sides of the eighth through holes, of the safety doors are provided with inclined faces aligned with the jacks, first clamping blocks are arranged on upper and lower sides of the seventh through holes, and grooves allowing the first clamping blocks to be inserted thereinto are provided in inner side faces of the safety doors.

4. The GFCI socket according to claim 2, wherein two ends of the contact bridges are provided with movable contacts, the conductive sheets are provided with first static contacts aligned with the movable contacts at upper ends of the contact bridges, one end of the first circuit board is connected to a mutual inductor, the mutual inductor is provided with second static contacts aligned with the movable contacts at lower ends of the contact bridges, and a lower end of the reset key is provided with a driving structure capable of being linked with the linkage frame.

5. The GFCI socket according to claim 3, wherein the driving mechanism comprises a driving rod and a lock catch arranged at a lower portion of the driving rod, a first spring driving the reset key to reset is arranged on the driving rod in a sleeving manner, a locking plate capable of cooperating with the lock catch is movably arranged in the linkage frame, the first circuit board is connected to an electromagnet, the electromagnet comprises a static iron core and a movable iron core, an annular groove is provided in an outer side of the movable iron core, a fourth spring is arranged between the movable iron core and the static iron core, a first through hole allowing the driving rod to be inserted thereinto is provided in the linkage frame, a second through hole allowing the locking plate to move therein is provided in the linkage frame, the locking plate is provided with a third through hole allowing the driving rod and the lock catch to pass therethrough, and blocking sheets capable of moving in the annular groove are arranged at two ends of one side of the locking plate.

6. The GFCI socket according to claim 5, wherein a movable frame is arranged on the linkage frame, a fourth through hole allowing the driving rod to be inserted thereinto is provided in the movable frame, a second clamping block is arranged on the movable frame, a touch plate is detachably connected onto the movable frame, a convex portion allowing the second clamping block to be buckled is arranged on the linkage frame, a contact capable of abutting against the touch plate is arranged on the first circuit board, a third spring for promoting the movable frame to move outwards is arranged between the movable frame and the linkage frame, a first convex block is arranged on the movable frame, and a first buckle capable of being buckled with the first convex block is arranged on the touch plate.

7. The GFCI socket according to claim 5, wherein a support is arranged on the middle frame, a second circuit board is arranged on the support, a contact piece connected to the first circuit board is arranged on the support and the middle frame in a penetrating manner, a swing sheet is bent inwards at an upper end of the contact piece, a lower end of the test key abuts against the swing sheet, a contact capable of abutting against the swing sheet is arranged on the second circuit board, an indicator lamp penetrating out of the housing is arranged on the second circuit board, and the first spring is arranged between the middle frame and the reset key.

8. The GFCI socket according to claim 6, wherein a support is arranged on the middle frame, a second circuit board is arranged on the support, a contact piece connected to the first circuit board is arranged on the support and the middle frame in a penetrating manner, a swing sheet is bent inwards at an upper end of the contact piece, a lower end of the test key abuts against the swing sheet, a contact capable of abutting against the swing sheet is arranged on the second circuit board, an indicator lamp penetrating out of the housing is arranged on the second circuit board, and the first spring is arranged between the middle frame and the reset key.

9. The GFCI socket according to claim 7, wherein the middle frame is provided with a second slot allowing the linkage frame to move therein, the linkage frame is provided with guide opening grooves and guide stand columns, the contact bridges are provided with guide sheets movable in the guide opening grooves, the contact bridges are provided with fifth through holes allowing the guide stand columns to pass therethrough, a lower end of the middle frame is provided with a sleeve, and the sleeve is internally provided with second springs which are arranged on the guide stand columns in a sleeving manner and abut against the contact bridges.

10. The GFCI socket according to claim 2, wherein an opening is provided in a middle of the elastic sheet, a positioning block inserted into the opening is arranged in the upper housing, at least one pair of first stand columns for clamping and limiting left-right swing of the elastic sheet are arranged in each of the positions, on upper and lower sides of the positioning block, and second stand columns capable of abutting against the bent portions of the elastic sheet are further arranged in the upper housing.

11. The GFCI socket according to claim 3, wherein an opening is provided in a middle of the elastic sheet, a positioning block inserted into the opening is arranged in the upper housing, at least one pair of first stand columns for clamping and limiting left-right swing of the elastic sheet are arranged in each of the positions, on upper and lower sides of the positioning block, and second stand columns capable of abutting against the bent portions of the elastic sheet are further arranged in the upper housing.

12. The GFCI socket according to claim 9, wherein left and right sides of the lower housing each are provided with a second buckle, a periphery of the lower housing is provided with first screw holes, the upper housing is provided with second convex blocks capable of being buckled with the second buckles, the upper housing is provided with second screw holes aligned with the first screw holes, the first screw holes and the second screw holes are in threaded connection through bolts, and the middle frame is provided with ninth through holes for the bolts to pass therethrough.
